(19) United States
(12) Patent Application Publication
(10) Pub. No.: US 2021/0189055 A1
(43) Pub. Date: Jun. 24, 2021

(54) COMPOSITE STRUCTURE

(71) Applicant: Dow Global Technologies LLC, Midland, MI (US)

(72) Inventors: George A. Klumb, Midland, MI (US); Kaoru Aou, Lake Jackson, TX (US); Viraj K. Shah, Pearland, TX (US); Kelly F. Kiszka, Birch Run, MI (US)

(21) Appl. No.: 17/045,035

(22) PCT Filed: Apr. 12, 2019
(86) PCT No.: PCT/US19/27131

§ 371 Date: Oct. 2, 2020

Related U.S. Application Data
(60) Provisional application No. 62/677,408, filed on May 29, 2018.

(51) Int. Cl. C08G 18/76; C08G 18/48; B29C 44/12; B29C 44/60

(52) U.S. Cl. CPC C08G 18/7664; C08G 18/48; C08G 2101/00; B29C 44/60; B29C 44/1276

(57) ABSTRACT

A composite structure including (a) a three-dimensional random loop material comprising a plurality of random loops arranged in a three-dimensional orientation formed from a polyolefin polymer; and (b) a polyurethane foam in contact with substantially all of the surfaces of the three-dimensional random loop material; wherein the polyurethane foam can be the reaction product of (a) an isocyanate component; and (b) an isocyanate-reactive component; and a method of making the above polyurethane foam and three-dimensional random loop composite structure.

### REFERENCE TO RELATED APPLICATIONS

The present application claims the benefit of U.S. Provisional Application No. 62/677,408, filed on May 29, 2018.

### FIELD

The present invention relates to a composite structure of a polyurethane foam material combined with a three-dimensional oriented random loop structure material; and a method of preparing such composite structure.

### BACKGROUND

Polyurethane (PU) foams and three-dimensional oriented random loop structure (“3DL”) materials are known materials. Heretofore, these known materials have been used for various applications such as to prepare an open foam for mattress applications such as described in WO2018017363A1. For example, WO2018017363A1 discloses viscoelastic polyurethane foams containing 3DL materials. WO2018017363A1 discloses manufacturing a composite article by layering and bonding together the two materials (PU foam and 3DL material) such that the composite article has the proper air flow and cushioning properties.

Acoustical applications often require foams of only low levels of load bearing. Also, in order to achieve the required acoustical performance, the formulation is often such that only low levels of load bearing are obtained; that is, when high levels of load bearing is targeted, acoustical performance is reduced. Some acoustical applications require areas of higher load bearing than other areas in the foam, in order for the foam to work properly. Load bearing property can be measured by a Compression Load Test with 300 Newtons (N) of force yielding a displacement after 10 seconds (s), for a sample of thickness 50 millimeters (mm), and a higher load bearing is characterized by displacement value that is 75 percent (%) or less than the displacement observed for a benchmark foam. Known composite articles made from PU foam and 3DL material are layered composites, and such known layered composites do not meet the requirements of having said high load bearing while simultaneously maintaining a functional acoustic property such as a sound absorption coefficient in the frequency range 2,100 Hertz (Hz) to 3,100 Hz of, for example, above 0.80. Thus, there is still a need to increase the load bearing of a polyurethane foam without losing any of its sound absorption characteristics.

### SUMMARY

The problem of the prior art related to increasing the load bearing of a polyurethane foam without losing any of its sound absorption properties can be solved by the present invention. The present invention provides a foam composite structure of a polyurethane foam and 3DL material such that the load bearing of the polyurethane foam increases without impacting the acoustic properties of the polyurethane foam.

One embodiment of the present invention includes a composite structure comprising: (a) a three-dimensional random loop material comprising a plurality of random loops arranged in a three-dimensional orientation formed from a polyolefin polymer; and (b) a polyurethane foam in contact with substantially all of the surfaces of the three-dimensional random loop material; wherein the polyurethane foam includes the reaction product of (a) an isocyanate component; and (b) an isocyanate-reactive component.

Another embodiment of the present invention includes a method of making a polyurethane foam and 3DL composite structure by carrying out the steps of: (I) admixing (a) a polyisocyanate component, and (b) a polyol component, forming a foam-forming reactive mixture; (II) contacting the foam-forming reactive mixture with a 3DL structure such that substantially all of the spaces in the 3DL structure are filled with the foam-forming reactive mixture to substantially envelope completely the 3DL structure with the foam-forming reactive mixture; and (III) allowing the foam-forming reactive mixture to react for a predetermined period of time and under conditions to form a polyurethane foam and 3DL composite structure. In a preferred embodiment, a 3DL structure is placed in a mold and the contacting step (II) above is carried out by pouring the foam-forming reactive mixture into the mold to fill substantially all of the void areas (or spaces) in the 3DL structure with the foam-forming reactive mixture. And, once the foam-forming reactive mixture cures, the resulting polyurethane foam and 3DL composite structure is removed from the mold. When the resulting composite is removed from the mold and tested for its acoustical properties, surprisingly the composite is found to have acoustic properties very similar to the foam without the 3DL material and yet still have a high load bearing required for use of the composite.

### BRIEF DESCRIPTION OF THE DRAWINGS

FIG. 1 is a photograph showing four samples of cut-out test specimens used to test the acoustic properties of the specimens. The samples of cut-out test specimens were cut from sheets of the following materials: (1) a sheet of 3DL/PU foam composite material labeled specimen “SAMPLE A”; (2) a sheet of non-3DL material labeled specimen “SAMPLE B”; (3) a sheet of 3DL material (no PU foam) labeled specimen “SAMPLE C”; and (4) a sheet of non-3DL firm material labeled specimen “SAMPLE D”.

FIG. 2 is a graphical illustration showing the test results of the average sound absorption testing of the cut-out test specimens shown in FIG. 1.

### DETAILED DESCRIPTION

Polyurethane (PU) foams are typically made by reacting a reactive polyurethane foam-forming composition, formulation or system which includes the reaction of a polyisocyanate component (a) comprising one or more polyisocyanate compounds with a polyol component (b) comprising one or more polyol compounds. Preferably the reaction can be carried out in the presence of (c) one or more blowing agents and (d) one or more catalysts such as described in U.S. Pat. No. 7,714,030. When the above components (a)-(d) are mixed and reacted, the reaction forms a polyurethane foam.

The PU foam-forming system (or PU foam reactive composition) including the above components (a)-(d) can be combined with a 3DL structure and reacted to form a PU foam/3DL composite structure having beneficial properties such as increase load bearing while maintaining the acoustic properties of the composite structure.

The polyisocyanate component, component (a), useful for preparing the polyurethane foam-forming composition may include for example one or more polyisocyanate compounds or isocyanate-terminated prepolymers such as m-phenylene diisocyanate; 2,4-and/or 2,6-toluene diisocyanate (TDI); the various isomers of diphenylmethanediisocyanate (MDI); the so-called polymeric MDI products; carbodiimide modified MDI products; hexamethylene-1,6-diisocyanate; tetramethylene-1,4-diisocyanate; cyclohexane-1,4-diisocyanate; hexahydrotoluene diisocyanate; hydrogenated MDI; naphthylene-1,5-diisocyanate; and mixtures thereof. The polyisocyanate component (a) can have an average functionality of isocyanate groups of, for example, from 2.0 to 3.0 in one embodiment and from 2.0 to 2.3 in another embodiment.

The polyol component, component (b), useful for preparing the polyurethane foam-forming composition may include for example one or more polyol compounds known in the art such as alkylene glycols such as ethylene glycol, propylene glycol, 1,4-butane diol, 1,6-hexanediol and the like, and mixtures thereof; glycol ethers such as diethylene glycol, triethylene glycol, and the like, and mixtures thereof; tertiary amine-containing polyols; polyether polyols; polyester polyols; and mixtures thereof. The functionality (average number of isocyanate-reactive groups/molecule) of the polyol component can be, for example, from 2 to 2.5 in one embodiment and from 2.1 to 2.3 in another embodiment.

A variety of other conventional components can be added to the polyisocyanate component (a) and/or the polyol component (b) to form the PU foam system. Suitable components for the PU foam system are well known in the art and can include, for example, blowing agents such as water and various chemical blowing agents; catalysts for example tertiary amines such as trimethylamine, triethylamine, N-methyl morpholine, N-ethyl morpholine, N,N-dimethylbenzylamine N,N,N-trimethyl-N-hydroxyethyl-bis(aminoethyl) ether, and dimethyl 1-2(2-aminoethoxy) ethanol, triethylenediamine; chelates of various metals; acidic metal salts of strong acids such as ferric chloride; salts of organic acids with variety of metals, such as alkali metals; organometallic derivatives of tetravalent tin, trivalent and pentavalent As, Sb and Bi and metal carbonyls of iron and cobalt; and the like; and mixtures thereof. Other optional compounds or additives that may be added to the foam formulation may include, for example, one or more of surfactants such as a silicone polyether (SPE) surfactant; other co-catalysts, toughening agents, flow modifiers, adhesion promoters, diluents, stabilizers, plasticizers, catalyst de-activators, flame retardants, liquid nucleating agents, solid nucleating agents, Ostwald ripening retardation additives, and mixtures thereof.

The compounds or additives, when used in the foam composition, can be generally in the range of from 0 weight percent (wt %) to 10 wt % in one embodiment; and from 0.1 wt % to 5 wt % in another embodiment.

In one broad embodiment, the process for making the reactive foam composition includes admixing components (a) and (b) described above; and adding a blowing agent and a catalyst, components (c) and (d), respectively, to the foam composition. Generally, the preparation of the foam composition includes providing at least one polyisocyanate component (a) which can also be referred to herein as the “A-side” of the foam composition; and providing at least one polyol component (b) which can also be referred to herein as the “B-side” of the foam composition. The blowing agent component (c) and the catalyst component (d) may be added to the foam formulation into (1) the component (a) or A-side; (2) the component (b) or B-side, or (3) both component (a) (A-side) and component (b) (B-side); and the blowing agent and catalyst can be added before the components (a) and (b) are mixed together or after the components (a) and (b) are mixed together. One or more additional optional components may be added to the polyisocyanate component (a) and/or to the polyol component (b) of the formulation as desired.

In preparing the foam composition, the A-side and the B-side are separately and individually prepared with the ingredients (a)-(d) and the other optional ingredients, if any; and all of the components can be mixed together in the desired concentrations discussed above to prepare the foam composition. The mixing of the components can be carried out at a temperature of from 20° C. to 35° C. in one embodiment. The order of mixing of the ingredients is not critical and two or more compounds can be mixed together followed by addition of the remaining ingredients. The ingredients that make up the foam composition may be mixed together by any known mixing process and equipment. For example, the polyisocyanate component premix (A-side) and the polyol premix (B-side) can be mixed together by any known urethane foaming equipment.

In a broad embodiment, a process for making the foam includes admixing and reacting components (a) and (b) described above as introduced by way of an A-side and a B-side. The A-side and/or the B-side can include any of a number of optional components or additives; for example, the B-side may include blowing agent and a catalyst.

To manufacture the PU foam, the A-side is mixed with the B-side, at preferably ambient temperature and at the desired ratio, forming the reactive formulation. The resulting reactive blend is then subjected to conditions, such as an elevated temperature, sufficient to allow the foaming reaction to occur and to cure the reactive formulation to form a foam. Generally, the reactive PU foam-forming formulation can be injected or poured into a mold cavity followed by a subsequent curing of the formulation in the mold at a predetermined temperature and for a desirable amount of time to form the foam.

For example, the PU foam-forming formulation once in contact with the 3DL material can be cured at a temperature of from 37° C. to 71° C. in one embodiment. The time of curing can be for example from 60 s to 180 s in one embodiment. The foam produced in accordance with the process above has certain advantageous properties and benefits.

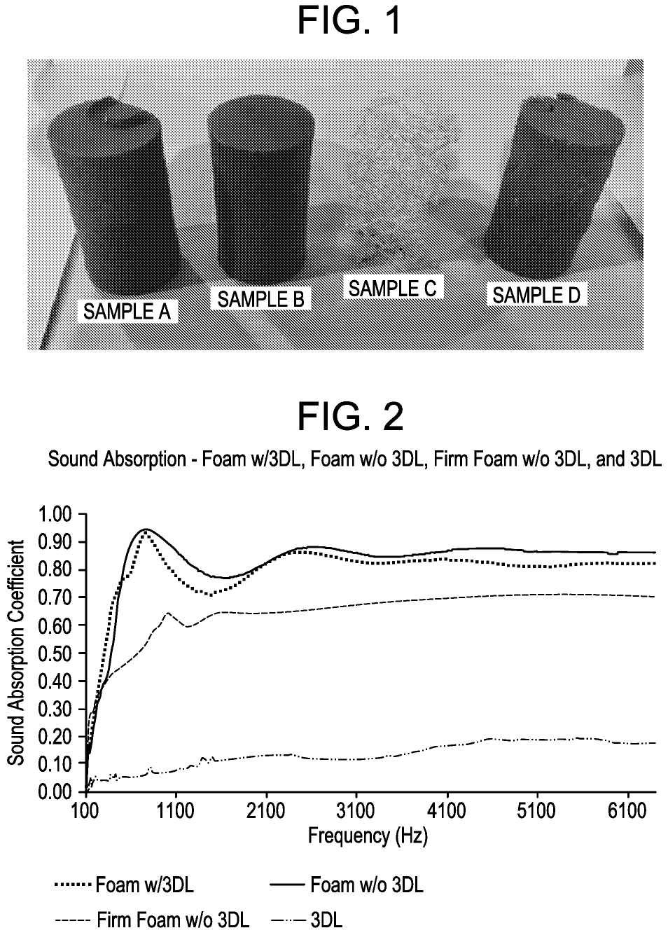

The 3DL material useful in the present invention can be, for example, any of the three-dimensional random loops prepared in accordance with the procedures described in U.S. Pat. Nos. 5,639,543, 7,622,179, and 7,625,629; and U.S. Patent Application Publication No. US20160122925. For example, as shown in FIG. 1 and FIG. 2 of US20160122925 and described in US20160122925, the process of making a cushioning structure with a 3DL material includes delivering a molten thermoplastic polymer, such as an ethylene/α-olefin copolymer blend, to a water-cooling unit and cooling the molten ethylene/α-olefin copolymer blend to facilitate the formation of the 3D random loops.

In one embodiment, the ethylene/α-olefin copolymer blend, in a molten or melted state, is delivered to the water-cooling unit via a drive mechanism (e.g., a belt, a plurality of rollers, a conveyor, or combinations thereof) which can be partially submerged, or fully submerged, within the water cooling unit.

One or more embodiments of the process may include, for example, the steps of heating and melting ethylene/α-olefin copolymer blend pellets in an extruder. Generally, the extruder may include a hopper, screw and barrel, motor to turn the screw and heaters to heat the barrel. In the process, the ethylene/α-olefin copolymer blend pellets enter the hopper; the pellets are melted in the heated barrel due to heat and shear; and then a molten ethylene/α-olefin copolymer blend exits a die of the extruder under positive pressure.

The molten ethylene/α-olefin copolymer blend exiting the die, under positive pressure, is transferred through a heated transfer pipe into another die that consists of several rows of holes in series. The melt, which enters the die from a round transfer pipe, is uniformly distributed so that the melt can exit the die from each of the individual holes uniformly. The die is in a horizontal arrangement such that the melt exiting the die is in the form of fibers and the fibers travels downward vertically toward the water before breaking the surface of the water in the water tank.

Water cooling the molten ethylene/α-olefin copolymer blend solidifies the molten material to form three-dimensional random loops which bond together to form a cushioning net structure. The drive mechanism which is typically an underwater mechanism constrains a thickness of the cushioning net structure. Because of the significant number of fibers being delivered to the water cooling unit, significant bonding of the fibers occurs during looping thereby creating a cushioning net structure. The continuously forming three-dimensional random loops cushioning net structure leaving the water unit can then be cut into a desired length as the structure leaves the cooling unit.

The three-dimensional looped structures formed as described are bonded with one another to form the 3D random loops cushioning net structures. The loop size of the random loops may vary depending on several factors. For example, the loop size may be dictated by the application of the structure; by the diameter of the holes in the die; by the polymer used; the melt temperature of the fibers or filaments coming out of the die; the distance between the die and water surface; the speed of the belts or rollers or other drive mechanism used under water; and the like. Generally, the random loop may have a diameter of from 0.1 mm to 3 mm in one embodiment, and from 0.4 mm to 1.6 mm in another embodiment. The thickness of the three-dimensional looped structures may range from 0.5 inch (12.7 mm) to 6 inches (152.4 mm). The apparent density of the random loop may range from 0.016 grams per cubic centimeter (g/cm³) to 0.1 g/cm³ in one embodiment; and from 0.016 g/cm³ to 0.1 g/cm³ in another embodiment.

As aforementioned, the composite articles are manufactured by injecting or pouring the reactive PU foam-forming formulation into a mold cavity which contains the 3DL material followed by a subsequent curing of the formulation in the mold with the 3DL. In general, the process steps include, for example, placing a sample of 3DL material into a mold, pouring a reacting polyurethane polymer composition into the mold, closing the mold and then allowing the rising, reacting polyurethane foam to fill the mold throughout the 3DL material allowing the creation of a composite structure.

In one embodiment, the method for making a polyurethane foam and 3DL composite structure includes the steps of: (I) providing a mold with a 3DL structure disposed in the mold; (II) admixing (a) a polyisocyanate component, and (b) a polyol component, forming a foam-forming reactive mixture; (III) pouring the foam-forming reactive mixture into the mold to contact the 3DL structure and filling the spaces in the 3DL structure to substantially envelope the 3DL structure with the foam-forming reactive mixture; (IV) allowing the foam-forming reactive mixture to react for a predetermined period of time and under conditions to form the composite structure inside the mold; and (V) removing the resulting composite structure from the mold.

The composite structure includes at least one isocyanate to provide an isocyanate index of the reaction system in the range of from 50 to 100 in one embodiment, from 50 to 80 in another embodiment, and from 60 to 70 in another embodiment. “Isocyanate index” for purposes of this application is the ratio of isocyanate groups to isocyanate-reactive groups provided to the reaction mixture that forms the organic polymer.

The composite structure of the present invention has a sound absorption coefficient, as measured by the Sound Absorption Test in the frequency range 2,100 Hz to 3,100 Hz of greater than 0.80 in one embodiment.

The composite structure of the present invention has a load bearing property as measured in the Compression Load Test with 300 N of force yielding a displacement after 10 s, for a sample of thickness 50 mm, that is 75% or less than the displacement observed for a PU foam of the exact same formulation but without the 3DL.

The composites can be useful in a variety of applications. Generally, for example, articles made from the foam/3DL composites are useful in applications such as comfort, sound absorption including noise dampening, harshness dampening, protection, packaging, medical equipment, safety equipment and combinations thereof. For example, foam/3DL composites are useful for any of the uses of existing foams, for instance, comfort applications such as mattresses, pillows and cushioning for seating, for sound absorption, for vibration dampening and combinations thereof. Additionally, the foams are useful in a variety of packaging and cushioning applications, such as mattresses, packaging, bumper pads, sport and medical equipment, helmet liners, pilot seats, earplugs, and various noise and vibration dampening applications; and combinations thereof.

In one embodiment, the polyurethane foam/3DL composites are particularly suitable for vehicle applications requiring noise, vibration, and harshness (NVH) reduction. For example, the polyurethane foam can be used in vehicle trim parts, headliners, instrument panels, under the hood applications, and the like. However, it is to be appreciated that the polyurethane foam can have applications beyond vehicle applications.

### EXAMPLES

The following examples are presented to further illustrate objects and advantages of the present invention but are not to be construed as limiting the scope of the claims. The particular materials and amounts thereof, as well as other conditions and details, recited in these examples should not be used to limit this invention. Unless stated otherwise all percentages, parts and ratios are by weight. Examples of the invention are numbered while comparative samples, which are not examples of the invention, are designated alphabetically.

Various raw materials, used in the examples which follow, are described as follows:

SPECFLEX* NS 648 LC is a blend of polyether polyols, water, silicone surfactants, catalysts and additives; and is available from The Dow Chemical Company (Dow).

SPECFLEX* NM 862 is a blend of polyether polyols, water, catalysts and additives; and is available from The Dow Chemical Company (Dow).

SPECFLEX* NE 520 is a polymeric MDI (polymethylene polyphenylisocyanate); and is available from Dow.

SPECFLEX* NS 1540 is a polymeric MDI (polymethylene polyphenylisocyanate); and is available from Dow.

*SPECFLEX is a trademark of The Dow Chemical Company.

The 3DL samples, used in the examples which follow, were as follows:

The 3DL structure, Sample Structure (I), was made from ELITE™ 5815 Enhanced Polyethylene resin and available from The Dow Chemical Company. Sample Structure (II) was 2 inches (50.8 mm) thick and had a density of 2.3 pounds per cubic foot (1b/ft³) (0.0368 g/cm³).

The 3DL structure, Sample Structure (II), was made from a proprietary polyethylene resin referenced as XUS 59999.36 and available from The Dow Chemical Company. Sample Structure (II) was 2 inches (50.8 mm) thick and had a density of 2.3 lb/ft³ (0.0368 g/cm³).

### General Procedure for Composite Sample Preparation

In general, the samples used in the examples were prepared as follows: The mold used in the examples was 20 inches (51 cm)×20 inches (51 cm)×2 inches (5.1 cm) with a lid. A 3DL material was cut to the above size of the mold and placed into (inside) the mold. The PU foam-forming composition was poured via a Graco high pressure foam machine into the mold. The foam-forming composition was poured onto and through the entire 3DL material and the composition was allowed to flow through the matrix of the 3DL material. Then, the lid to the mold was closed prior to the foam rising to the height of the edge of the mold. The mold was heated to 130° F. (54° C.) and the foam/3DL composite sample was demolded in 3 minutes.

### Compression Load Test

A sample (test specimen) having a dimension of 150 mm×150 mm and 50 mm thickness is used for a compression load test. A fixed force is applied to the test specimen using a 75 mm circular plate at the center of the sample specimen, and the displacement is measured. The loads applied were 100 N, 200 N, and 300 N. Then, 10 s after the load is applied, the thickness is recorded. This is done 4 times for each of the different specimens and the resulting measurements are averaged as the “Extension.”

### Sound Absorption Test

The objective of the tests conducted on the composite samples was to measure the normal incidence sound absorption coefficient of 3DL and non-3DL foam specimens. The normal incidence sound absorption coefficient was measured for the foam samples according to the ASTM E1050 standard. The samples were placed into the end of a Bruel & Kjaer 4206 impedance tube and rigid backing plate sealed the end. A loudspeaker at the opposite end of the tube was used to generate planar sound waves that travel down the tube. A white noise signal was fed into the loudspeaker to generate noise over a broad frequency range. In order to maintain a planar sound wave, two impedance tube sizes (a 29 mm diameter tube and a 100 mm diameter tube) are generally used. These two tube sizes cover different frequency ranges, as follows: (1) 29 mm diameter=500 Hz-6,400 Hz; and (2) 100 mm diameter=100 Hz-1,600 Hz.

Most often the 29 mm diameter tube is used since the 29 mm diameter tube covers a larger frequency range, and a frequency range that is more sensitive to the human ear. To perform the sound measurements, two microphones were used to measure the sound pressure level at known locations along the tube's length. A Bruel & Kjaer 3560 spectrum analyzer system was used to measure the sound pressure level signals from each microphone and the measured signals were used to compute the normal incidence sound absorption coefficient. The testing equipment system collects 100 measurements and averages the results together to eliminate variability.

### General Procedure for Test Specimen Preparation

Very close to true cylindrical specimens for testing were cut from blocks of composite samples. A tooth-less hole saw bit and cordless drill were used to extract the specimens. The dimensions of the cylindrical specimens were 29 mm in diameter and 50 mm in height.

### Examples 1 and 2 and Comparative Examples A and B

The components of the foam composition and the 3DL material for each of the examples; and mechanical properties, are described in Table I.

TABLE I

| | EXAMPLE | | | |
|---|---|---|---|---|
| | Comp. Ex. A | Comp. Ex. B | Inv. Ex. 1 | Inv. Ex. 2 |
| | (“Non-3DL”) | (“Non-3DL Firm”) | (“3DL”) | (“3DL”) |
| COMPONENT B | wt % | wt % | wt % | wt % |
| SPECFLEX ™ NS 648 LC | 100.0 | | 100.0 | 100.0 |
| SPECFLEX ™ NM 862 | | 100.0 | | |
| Total Polyol Components | 100.00 | 100.00 | 100.00 | 100.00 |
| COMPONENT A | wt % | wt % | wt % | wt % |
| SPECFLEX ™ NS 1540 | 100.0 | | 100.0 | 100.0 |
| SPECFLEX ™ NE 520 | | 100.0 | | |
| Isocyanate Index | 67.5 | 95.0 | 67.5 | 67.5 |
| Component B/Component A ratio | 2.16 | 2.39 | 2.16 | 2.16 |
| | | | Sample | Sample |
| 3D Loop* | | | Structure (I) | Structure (II) |
| Grade or Product Designation | | | ELITE ™ 5815 | XUS 59999.36 |
| Amount in foam composite (wt %) | | | 34 | 34 |
| FOAM COMPOSITE | | | | |
| CHARACTERISTICS | | | | |
| Density (kg/m\hat{ }3) | 65 | 96 | 98 | 98 |
| Compression Test Results | | | | |
| Extension after 2-hour dwell, mm | 40.76 | 30.51 | 32.97 | 33.65 |
| Extension at 100 N, mm | 23.45 | 3.32 | 8.92 | 8.47 |
| Extension at 200 N, mm | 34.56 | 13.47 | 20.37 | 20.78 |
| Extension at 300 N, mm | 38.05 | 22.22 | 27.32 | 28.14 |

Notes for Table I: *The 3D Loop used in the Examples is as described in WO2016130602A1.

Three samples, Comparative Example (Comp. Ex.) A, Comp. Ex. B and Inventive Example (Inv. Ex.) 1, designated as “3DL” (Inv. Ex. 1), “Non 3DL” (Comp. Ex. A), and “Non 3DL firm” (Comp. Ex. B), as described in Table I, were used in the Examples for testing. Table I describes the mechanical properties of the samples. The intent of using 3DL (Inv. Ex. 1) was to increase the load bearing capability of the foam compared with a regular PU foam, e.g., Non 3DL (Comp. Ex. A).

The above three samples and a sample of 3DL material without foam were studied for sound absorption coefficients as functions of frequency. The second PU foam, Non 3DL Firm (Comp. Ex. B), was prepared and used to demonstrate that the acoustic performance of the foam can deteriorate when the load bearing of the PU foam is made firm. The test results for the acoustic properties of the samples are described with reference to FIGS. 1 and 2 shows that the Non-3DL and 3DL foam samples exhibit good overall sound absorption characteristics (e.g., >70% over the entire tested frequency range).

The Non 3DL and 3DL foam specimens exhibit a higher initial peak in the sound absorption (between 500 Hz-1,000 Hz). Typically, this can be due to higher air flow resistivity which can be created by a thicker skin, small cells, small cell window openings, or presence of closed cell windows.

The Non-3DL and 3DL foam specimens also exhibit a secondary peak in the 2,100 Hz to 3,100 Hz range. This range generally pertains to vehicles, especially for vehicle floor mats when acoustic performance analysis is usually carried out. The 3DL foam showed sound absorption coefficient of greater than 0.80 in this frequency range.

The sound absorption properties of both the 3DL and Non 3DL foam specimens are similar—that is, the curve shape and primary and secondary peaks of the 3DL and non-3DL were very similar. However, the “Non 3DL Firm” specimens exhibit considerably lower overall sound absorption than the Non −3DL and 3DL specimens. Absorption of >70% for the non-3DL firm specimens can only be seen at, or above, 4,100 Hz. Both 3DL and “Non-3DL Firm” are high load bearing materials compared with the “Non 3DL” sample, however the 3DL material outperformed the “Non 3DL Firm” foam across the entire tested frequency range.

What is claimed is:

1. A composite structure comprising:
(a) a three-dimensional random loop material comprising a plurality of random loops arranged in a three-dimensional orientation formed from a thermoplastic polymer; and
(b) a polyurethane foam in contact with substantially all of the surfaces of the three-dimensional random loop material; wherein the polyurethane foam includes the reaction product of (a) an isocyanate component; and (b) an isocyanate-reactive component.

2. The composite structure of claim 1, wherein the thermoplastic polymer is a polyolefin polymer.

3. The composite structure of claim 1, wherein the polyolefin polymer is a polyethylene polymer.

4. The composite structure of claim 1, wherein the composite structure has a sound absorption property of greater than 0.80.

5. The composite structure of claim 1, wherein the composite structure has a load bearing property as measured in the Compression Load Test with 300 N of force yielding a displacement after 10 seconds, for a sample of thickness 50 millimeters, that is 75 percent or less than the displacement observed for a polyurethane foam of the exact same formulation but without the 3DL.

6. The composite structure of claim 1, wherein the at least one isocyanate has an isocyanate index of the reaction system being from 50 to 100.

7. The composite structure of claim 2, wherein the polyolefin polymer is an ethylene/alpha-olefin polymer having a density ranging from 0.895 grams/cubic centimeter to 0.925 grams/cubic centimeter and a melt index ranging from 3 grams/10 minutes to 25 grams/10 minutes as measured according to ASTM D1238 at 190° C. and 2.16 kg load.

8. The composite structure of claim 2, wherein the polyolefin polymer is a propylene interpolymer comprising at least 60 weight percent units derived from propylene and between 1 weight percent units and 40 weight percent units derived from ethylene; wherein the propylene interpolymer has a density of from 0.840 g/cm³ to 0.900 g/cm³, a highest differential scanning calorimetry temperature melting peak of from 50° C. to 120° C., and a melt flow rate of from 1 g/10 minutes to 100 g/10 minutes as measured according to ASTM D1238 at 230° C. and 2.16 kilogram load.

9. The composite structure of claim 1, wherein each of the plurality of random loops has a mean fiber diameter of from 0.1 millimeters to 3.0 millimeters.

10. The composite structure of claim 9, wherein each of the plurality of random loops has an apparent density in a range of 0.016 g/cm³ to 0.1 g/cm³.

11. A polyurethane foam and 3DL composite structure made by the method of claim 1.

12. The composite structure of claim 11, wherein the composite structure has an increased load bearing property as measured in the Compression Load Test with 300 N of force yielding a displacement after 10 seconds, for a sample of thickness 50 millimeters, that is 75 percent or less than the displacement observed for a polyurethane foam of the exact same formulation but without the 3DL, and wherein the sound absorption coefficient of the composite structure is maintained at greater than 0.8 between the frequency range of 2,100 Hertz to 3,100 Hertz.

13. A method of making a polyurethane foam and 3DL composite structure comprising the steps of:
(I) providing a three-dimensional random loop material comprising a plurality of random loops arranged in a three-dimensional orientation formed from a polyolefin polymer;
(II) admixing (a) a polyisocyanate component, and (b) a polyol component, forming a polyurethane foam-forming reactive mixture;
(III) providing a mold adapted for receiving the three-dimensional random loop material configuration and the polyurethane foam-forming reactive mixture;
(IV) positioning the three-dimensional random loop material configuration in the mold;
(V) pouring the polyurethane foam-forming reactive mixture into the mold containing the three-dimensional random loop material configuration sufficient to contact the three-dimensional random loop material configuration and sufficient for the polyurethane foam-forming reactive mixture to flow onto and through the three-dimensional random loop material configuration in the mold and sufficient to fill the spaces in three-dimensional random loop material configuration to substantially envelope the three-dimensional random loop material configuration with the polyurethane foam-forming reactive mixture;
(VI) allowing the polyurethane foam-forming reactive mixture to react for a predetermined period of time and under conditions to form a polyurethane foam and three-dimensional random loop material composite structure inside the mold; the composite structure having a load bearing property as measured in the Compression Load Test with 300 N of force yielding a displacement after 10 seconds, for a sample of thickness 50 millimeters, that is 75 percent or less than the displacement observed for a polyurethane foam of the exact same formulation but without the 3DL; and
(VII) removing the composite structure from the mold.

14. The method of claim 13, wherein the polyol component (b) is selected from one or more of polyester polyols, polyether polyols, polycarbonate polyols, and mixtures thereof.

15. The method of claim 13, wherein the 3DL structure is made of a polyolefin material.
